(19) United States
(12) Patent Application Publication
(10) Pub. No.: US 2004/0194298 A1
(43) Pub. Date: Oct. 7, 2004

(54) Sheathed metal tube and method therefor

(76) Inventors: Andreas Sausner, Frankfurt (DE); Georg Weick, Plankstadt (DE); Delbert L. Adkins, Clinton Township, MI (US); David Poirier, Fort Gratiot, MI (US)

Correspondence Address: JENNER & BLOCK, LLP, ONE IBM PLAZA, CHICAGO, IL, 60611, US

(21) Appl. No.: 10/796,934

(22) Filed: Mar. 9, 2004

(30) Foreign Application Priority Data
Mar. 25, 2003 (DE) 10313242.2

(51) Int. Cl. H01R 43/00

(52) U.S. Cl. 29/825

(57) ABSTRACT

In a method for grounding a metal tube (2) sheathed with an electrically non-conducting plastic layer (1), has the plastic layer (1) of the metal tube (2) completely removed at an area of connection (3) the area of connection (3) is connected to the motor vehicle part in an electrically conducting fashion by a conductive covering section (4) is closed in the circumferential direction of the metal tube (2) which covers the area of connection (3) on all sides or more than covers the area of connection (3) on all sides, i.e. in the form of a crimp sleeve or a heat-shrinkable sleeve. It is first pushed onto the metal tube (2) and is then pressed onto the metal tube (2) at least at its ends under radial pressure applied along at least part of the circumference without any gaps. In one form, the tube has a bead in the area where the plastic layer is removed and the bead is in contact with the conductive covering section.

### BACKGROUND OF THE INVENTION

This invention relates to a method for earthing (grounding) a metal tube sheathed with an electrically non-conducting plastic layer, which is used in a motor vehicle for transporting liquid or gaseous media, especially fuels, on a metal motor vehicle part, especially the chassis of the motor vehicle, wherein the plastic layer of the metal tube is completely removed at an area of connection and said area of connection is then connected to the motor vehicle part in an electrically conducting fashion.

Within the scope of the invention, the metal tube is preferable made of single-layer welded or multi-layer soldered steel tube which is provided on the outside with a base-metal layer (e.g. AI, Zn or Galfan) as an anti-corrosion layer.

In a method of said type known from practice which is not confirmed in detail in publications, the area of connection is connected directly to the motor vehicle part in an electrically conducting fashion. As a result of the plastic layer being partly missing in the area of the joint, the corrosion and abrasion resistance of the metal tube unfortunately deteriorates.

The object of the invention is to provide a perfect electrical join between metal tube and the other motor vehicle part such as chassis within the framework of the measures specified initially without impairing the corrosion and abrasion resistance.

For this purpose the present invention teaches that a covering section which covers the area of connection on all sides or preferably more than covers said area of connection is first pushed onto the metal tube and is then pressed onto the metal tube at least at its ends under radial pressure applied along at least part of the circumference without any gaps, and the covering section is then connected to the motor vehicle part in an electrically conducting fashion. The covering section can be pressed onto the metal tube without any gaps at least at its ends under radial pressure applied along the total circumference.

The invention in this case starts from the reasoning that the problem of inadequate corrosion and abrasion resistance of the metal tube can be eliminated by the fact that sealing of the exposed metal surface can be provided by an additional covering section so that the product is protected against external environmental influences such as contact with spray water, and the corrosion effects associated therewith.

The metal tube especially comprises a steel tube. As has already been described initially, an electrically conductive anti-corrosion layer, which consists of a base metal, for example, of zinc or aluminum, is suitably located on the metal tube. It is within the scope of the invention that the anti-corrosion layer is arranged between the metal tube and the plastic layer.

The plastic layer is removed at a certain point on the tube at a certain width. In this case, according to one embodiment, the plastic layer can be removed mechanically, for example, it can be peeled off. According to another embodiment of the invention, the plastic layer can however also be removed with the aid of laser treatment. The plastic layer can be removed either over the total circumference of the tube (360°) or over a partial area of the circumference (for example, 90°). The depth to which the plastic layer is removed in the radial direction of the tube either extends as far as the surface of the metal tube or as far as the electrically conductive anti-corrosion layer.

Within the scope of the invention there are a plurality of possibilities for the shaping of the electrically conductive covering section. According to one embodiment, the covering section is constructed as closed in the circumferential direction of the metal tube. According to a first preferred embodiment, the covering section consists of a metal crimp sleeve, especially of aluminum or stainless steel. It is recommended that this crimp sleeve is pressed on mechanically.

In a second, very preferred embodiment, the covering section consists of a heat-shrinkable sleeve made of an electrically conductive plastic or a plastic made conductive by additives. This heat-shrinkable sleeve is advantageously shrunk onto the metal tube by heat treatment. In this case, according to one embodiment, this heat-shrinkable sleeve is also provided on the inside with an electrically conductive adhesive coating.

According to a particular embodiment of the invention, a bead or upset, which runs around the circumference of the tube is first produced on the tube. The bead projects radially from the surface of the tube. It is especially within the scope of the invention to produce such a bead at one section of the tube. At least the plastic layer covering the bead is suitably removed and preferably over the total circumference of the bead. This exposed metal surface of the bead then forms the area of connection of the metal tube. The area of connection at such a bead has the advantage that the exposed metal surface is larger than a corresponding area of connection of the same width in another region of the tube. According to the invention, a heat-shrinkable sleeve made of electrically conductive plastic is applied/pushed onto the metal tube or onto the bead. This heat-shrinkable sleeve is then shrunk onto the metal tube or onto the bead by heat treatment. In this case, the heat-shrinkable sleeve can be provided on the inside with an electrically conductive adhesive coating.

The subject matter of the invention is also a sheathed metal tube according to the claims 10.

### BRIEF DESCRIPTION OF THE DRAWINGS

FIG. 1 shows a cross-section through an electrically conducting joint of a metal tube with a motor vehicle part.

FIG. 2 shows a second embodiment of such a joint.

FIG. 3 shows a third embodiment of the subject matter from FIG. 1.

### DETAILED DESCRIPTION OF THE DRAWINGS

In order to earth (ground) a metal tube 2 sheathed with an electrically non-conducting plastic layer 1, which is used in a motor vehicle for transporting liquid or gaseous media, especially fuels, on a metal motor vehicle, especially the chassis of the motor vehicle, the plastic layer 1 of the metal tube 2 is completely removed at an area of connection 3 over the total circumference. A cylindrical covering section 4 which is closed in the circumferential direction of the metal tube 2 and which more than covers the area of connection 3 on all sides is pushed onto the metal tube 2 and is then pressed onto the metal tube 2 at least at its ends under radial pressure applied along at least part of the circumference without any gaps. The covering section is then connected to the motor vehicle part in an electrically conducting fashion which is not shown in detail. The covering section is illustrated as being of a cylindrical shape. However, numerous polygonal shapes which are generally annular but have a plurality of flat sidewalls are envisioned within the shape of the invention.

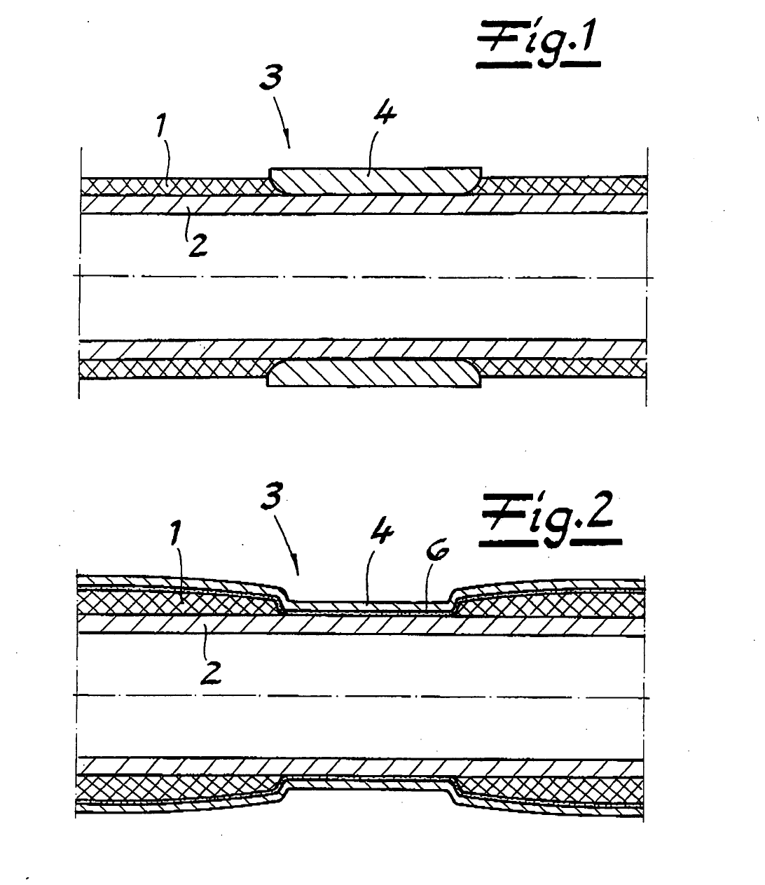

In the embodiment according to FIG. 1, the covering section 4 consists of a metal crimp sleeve made of aluminum or stainless steel. This crimp sleeve 4 is pressed on mechanically so that the crimp sleeve 4 has contact over its total length and thus also in the exposed part 3 of the metal tube 2.

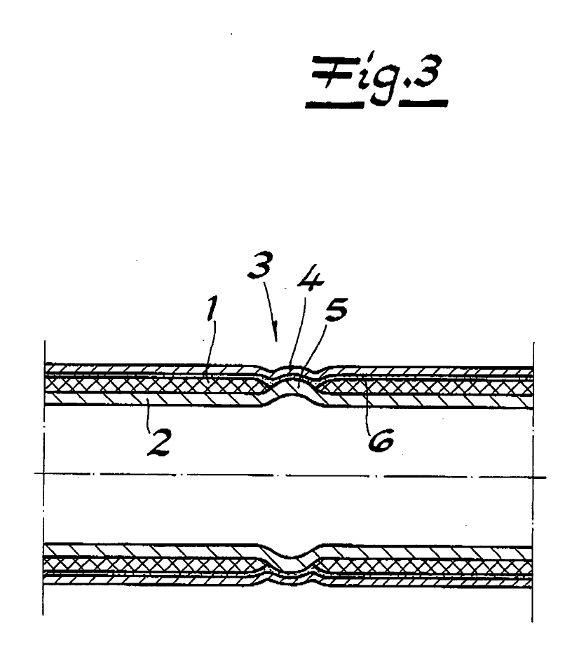

In the embodiment according to FIG. 2, the covering section 4 consists of a heat-shrinkable sleeve made of electrically conductive plastic or plastic made conductive by additives as is known. This heat-shrinkable sleeve 4 has been heat shrunk onto the metal tube 2 by heat treatment, wherein the heat-shrinkable sleeve 4 can have been initially provided with an electrically conductive inner layer on its inside. In this embodiment and in the embodiment shown in FIG. 3 which is explained subsequently, the pressing on of the covering section is accomplished under radial pressure by shrinking on.

In the embodiment according to FIG. 3 the covering section 4 consists of a heat-shrinkable sleeve made of electrically conductive plastic. In this embodiment a radially outwardly extending bead or upset 5 which runs around the circumference of the tube was first produced on the tube. The plastic layer 1 covering the bead 5 was removed and in this way the area of connection 3 was obtained on the bead 5. The heat-shrinkable sleeve 4 has been shrunk onto the metal tube 2 or onto the bead 5 by heat treatment. In this embodiment the heat shrinkable sleeve 4 is also provided with an electrically conductive adhesive coating 6 on the inside.

While in the foregoing embodiments of the invention have been disclosed in considerable detail for the purposes of illustration, it will be understood by those skilled in the art that many of these details may be varied without departing from the spirit and scope of the invention.

1. A method for grounding a metal tube (2) sheathed with an electrically non-conducting plastic layer (1), which is used in a motor vehicle for transporting liquid or gaseous media, especially fuels, on a metal motor vehicle part, especially the chassis of the motor vehicle, wherein the plastic layer (1) of the metal tube (2) is completely removed at an area of connection (3) and said area of connection (3) is then connected to the motor vehicle part in an electrically conducting fashion, characterized in that a conductive covering section (4) which covers the area of connection (3) on all sides or more than covers the area of connection (3) on all sides is first pushed onto the metal tube (2) and is then pressed onto the metal tube (2) at least at its ends under radial pressure applied along at least part of the circumference without any gaps and the covering section (4) is then connected to the motor vehicle part in an electrically conducting fashion.

2. The method according to claim 1, characterized in that the covering section (4) is constructed as closed in the circumferential direction of the metal tube (2).

3. The method according to any one of claims 1 or 2, characterized in that the covering section (4) consists of a metal crimp sleeve.

4. The method according to claim 3, characterized in that the crimp sleeve (4) consists of aluminum or stainless steel.

5. The method according to any one of claims 2 to 4, characterized in that the crimp sleeve (4) is pressed on mechanically.

6. The method according to any one of claims 1 or 2, characterized in that the covering section (4) consists of a heat-shrinkable sleeve made of electrically conductive plastic.

7. The method according to claim 6, wherein at least one bead (5) which runs around the circumference of the metal tube (2) is produced on said metal tube (2) and wherein the plastic layer (1) covering the bead (5) is removed at least over part of the bead circumference, preferably over the total bead circumference, and wherein the heat-shrinkable sleeve made of electrically conductive plastic is pushed onto the area of connection (3) on the bead (5).

8. The method according to any one of claims 6 or 7, characterized in that the heat-shrinkable sleeve (4) is shrunk onto the metal tube (2) by heat treatment.

9. The method according to any one of claims 6 to. 8, characterized in that the heat-shrinkable sleeve (4) is provided with an electrically conductive adhesive coating on the inside.

10. A metal tube (2) sheathed with an electrically non-conducting plastic layer (1) for transporting liquid or gaseous media, especially fuels in a motor vehicle, wherein the plastic layer (1) of the metal tube (2) is completely removed at an area of connection (3) and this area of connection (3) is connected in an electrically conducting fashion to be metal motor vehicle part, especially the chassis of the motor vehicle, characterized in that a conductive covering section (4) which covers the area of connection (3) on all sides or more than covers the area of connection (3) on all sides is first pushed onto the metal tube (2) and is then pressed onto the metal tube (2) at least at its ends under radial pressure applied along at least part of the circumference without any gaps and the covering section (4) is then connected to the motor vehicle part in an electrically conducting fashion.

11. The sheathed metal tube according to claim 10, wherein the covering section is a pressed-on metal crimp sleeve.

12. The sheathed metal tube according to claim 10, wherein the covering section (4) is a shrunk-on heat-shrinkable sleeve made of an electrically conductive plastic.

13. The sheathed metal tube according to claim 10 wherein said tube includes a bead extending radically outwardly at said removed area of said plastic layer and is in contact with said outer covering section.
